(19) United States
(12) Patent Application Publication
(10) Pub. No.: US 2026/0310289 A1
(43) Pub. Date: Oct. 8, 2026

(54) METHODS FOR PROCESSING AND TRANSFERRING IMAGE DATA AND IMAGE PROCESSING SYSTEMS

(71) Applicant: Varjo Technologies Oy, Helsinki (FI)

(72) Inventors: Niki Dobrev, Helsinki (FI); Mikko Ollila, Tampere (FI)

(73) Assignee: Varjo Technologies Oy, Helsinki (FI)

(21) Appl. No.: 19/170,607

(22) Filed: Apr. 4, 2025

(51) Int. Cl. G06F 3/01; G06T 3/4053; H04N 9/77

(52) U.S. Cl. CPC G06F 3/013; G06T 3/4053; H04N 9/77

(57) ABSTRACT

A method for processing and transferring image data in an image processing system (IPS), including: receiving, image(s) from image source(s) included in IPS; processing image(s) to generate: first image (FI) of first resolution by downscaling image(s), FI comprises first luminance plane (FLP) and first chrominance planes (FCPs); second image (SI) of second resolution by cropping given portion of image(s) corresponding to region of interest, comprising second luminance plane (SLP) and second chrominance planes (SCPs); separating SLP from SCPs of SI; transmitting, to host device (306): FI with FLP and FCPs, SI with SLP; receiving at host device: FI with FLP and FCPs, SI with SL; reconstructing SCPs for the SI, by extracting FCPs from FT and upscaling FCPs of FT using SL of SI as a reference plane; reconstructing, at host device, SI of second resolution.

### TECHNICAL FIELD

The present disclosure relates to methods for processing and transferring image data in image processing systems. Moreover, the present disclosure relates to image processing systems.

### BACKGROUND

High-resolution video transfer plays an essential role in various computer vision applications, such as in mixed reality (MR) systems, augmented reality (AR) systems, and similar. These systems rely on a video-pass-through (VPT) technology or a video-see-through (VST) technology, where camera-captured video is processed and displayed to a user in real time, often with additional virtual overlays. To ensure a seamless and immersive experience, a video transfer process must support high resolutions, high frame rates, and low latency. However, transferring large volumes of an image data from an image signal processor (ISP) or a front-end computer vision chip to a host computing device presents significant technical challenges, particularly due to bandwidth limitations in data transfer interfaces (for example, in a case of Universal Serial Bus (USB)). The limited USB bandwidth can degrade marker tracking performance by reducing image resolution or introducing latency, making it harder for a given system to detect and track markers accurately.

Conventionally, one of the primary issues caused by bandwidth limitations is an inability to transfer full-resolution video while maintaining real-time processing capabilities. When bandwidth is constrained, the given system may need to reduce a resolution, increase compression, or introduce latency, all of which can negatively impact both visual quality and real-time performance. For example, in Luxor front-end (FE) system, a gaze-based high-resolution cropping may be used to enhance visual clarity in the user's focus area. However, under limited bandwidth constraints, a cropped area (i.e., where the user is actively looking) may become noticeable to said user. The two primary factors contributing to this issue are small size of said cropped area and a large 4× downscale ratio applied to full-field image (i.e., a contrast between sharp crop area and blurry surroundings becomes even more noticeable to the user). Since increasing the crop resolution or reducing the downscale ratio may require additional data transfer capacity, the existing USB-based pipeline imposes constraints that make such improvements difficult to implement. As a result, optimizing data transfer efficiency is essential to overcoming these limitations while maintaining high-quality VPT/VST output.

Conventionally, to mitigate aforesaid bandwidth-related challenges, existing solutions primarily rely on foveated transfer method, which involves separately transmitting a high-resolution gaze-based crop along with a downscaled full-field image. Additionally, the use of YUV color space (i.e., Y represents luminance plane, and UV represents chrominance planes) helps to reduce a data size compared to red, green, blue (RGB) formats, making data transfer more efficient within an available bandwidth. Moreover, existing image compression methods can be employed to decrease data load, for example, such as Joint Photographic Experts Group (JPEG), Portable Network Graphics (PNG), H.265, and the like. However, these existing solutions face significant challenges in context of the VPT/VST. For example, many camera ISPs and front-end computer vision chips lack built-in support for such compression techniques, thereby preventing seamless implementation. Additionally, on the host personal computer (PC) side, decompression of these formats requires substantial computational resources and introduces additional processing time, which can affect real-time video processing efficiency. While hardware acceleration can mitigate some of the computational overhead, as seen with H.265 decoding, it does not fully resolve latency issues, making it suboptimal for MR/AR applications that demand real-time responsiveness. These issues are particularly problematic in head-mounted display (HMD) devices, where smooth and natural video rendering is essential for immersion.

Therefore, in light of the foregoing discussion, there exists a need to overcome the aforementioned drawbacks.

### SUMMARY

The aim of the present disclosure is to provide a method for processing and transferring image data in an image processing system and image processing system to efficiently transmit high-resolution region-of-interest image data while reducing bandwidth requirements by selectively downscaling and reconstructing chrominance information. The aim of the present disclosure is achieved by a method for processing and transferring image data, and image processing system as defined in the appended independent claims to which reference is made to. Advantageous features are set out in the appended dependent claims.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 illustrates steps of a method for processing and transferring image data in an image processing system, in accordance with an embodiment of the present disclosure;

FIG. 2 illustrates a block diagram of an image processing system, in accordance with an embodiment of the present disclosure; and

FIG. 3 illustrates an exemplary process flow for processing and transferring an image data in an image processing system, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, the present disclosure provides a method for processing and transferring image data in an image processing system, the method comprising:
receiving, at least one image from at least one image source comprised in the image processing system, wherein the at least one image comprises pixel data from at least one image sensor of the at least one image source, and wherein the at least one image source comprises one or more cameras with overlapping fields of view;
processing the at least one image to generate:
   a first image of a first resolution by downscaling the at least one image, wherein the first image comprises a first luminance plane and first chrominance planes; and
   a second image of a second resolution by cropping a given portion of the at least one image corresponding to a region of interest, comprising a second luminance plane and second chrominance planes, wherein the second resolution is greater than the first resolution;
separating the second luminance plane from the second chrominance planes of the second image, wherein the second chrominance planes are omitted during transmission to a host device;
transmitting, to a host device comprised in the image processing system:
   the first image with the first luminance plane and the first chrominance planes, and
   the second image with the second luminance plane;
receiving, at the host device:
   the first image with the first luminance plane and the first chrominance planes, and
   the second image with the second luminance plane;
reconstructing the second chrominance planes for the second image, by extracting the first chrominance planes from the first image and upscaling said first chrominance planes of the first image using the second luminance plane of the second image as a reference plane; and
reconstructing, at the host device, the second image of the second resolution, based on the reconstructed second chrominance planes and the second luminance plane.

The present disclosure provides the aforementioned first aspect for processing and transferring the image data in the image processing system. It will be appreciated that the method for processing and transferring the image data in the image processing system optimizes bandwidth usage by selectively transmitting only essential data.

Beneficially, by processing the at least one image to generate the first image of the first resolution by downscaling said at least one image and cropping the given portion of the at least one image to generate the second image of the second resolution, the method provides a structured approach to image encoding that balances detail retention in a region of interest while reducing overall data transfer requirements. Specifically, by separating the second luminance plane from the second chrominance planes of the second image and omitting transmission of the second chrominance planes, the method significantly reduces data load without compromising visual fidelity. Moreover, the method for processing and transferring the image data in the image processing system enhances real-time video processing performance by reducing computational overhead at the host device. The reconstruction process, leveraging shared chrominance data from the first image, enables efficient processing, making the method advantageous for latency-sensitive applications such as in mixed reality (MR) systems, augmented reality (AR) systems, and the like. Furthermore, the method enables high-resolution reconstruction of the second image at the host device without requiring transmission of redundant chrominance data.

In a second aspect, the present disclosure provides an image processing system comprising:
at least one image source configured to capture at least one image of an environment;
at least one imaging processor communicably coupled with the at least one image source, wherein the at least one imaging processor is configured to:
   receive at least one image from the at least one image source, wherein the at least one image comprises pixel data from at least one image sensor of the at least one image source, wherein the at least one image source comprises one or more cameras with overlapping fields of view;
   process the at least one image to generate:
      a first image of a first resolution by downscaling the at least one image, wherein the first image comprises a first luminance plane and first chrominance planes; and
      a second image of a second resolution by cropping a given portion of the at least one image corresponding to a region of interest, comprising a second luminance plane and second chrominance planes, wherein the second resolution is greater than the first resolution;
   separate the second luminance plane from the second chrominance planes of the second image, wherein the second chrominance planes are omitted during transmission to a host device; and
   transmit, to the host device:
      the first image with the first luminance plane and the first chrominance planes, and
      the second image with the second luminance plane; and
the host device comprising at least one first processor, wherein the at least one first processor is configured to:
   receive, from the at least one imaging processor:
      the first image with the first luminance plane and the first chrominance planes, and
      the second image with the second luminance plane; and
   reconstruct the second chrominance planes for the second image, by extracting the first chrominance planes from the first image and upscaling said first chrominance planes of the first image using the second luminance plane of the second image as a reference plane; and
   reconstruct the second image of the second resolution, based on the reconstructed second chrominance planes and the second luminance plane.

The present disclosure provides the aforementioned second aspect, which pertains to the image processing system configured for processing and transferring the image data. It will be appreciated that the image processing system optimizes data transmission efficiency by reducing an amount of chrominance data sent to the host device, thereby minimizing bandwidth consumption while ensuring an accurate image reconstruction. Beneficially, by utilizing the at least one image source comprising the one or more cameras with overlapping fields of view, the image processing system captures the at least one image of the environment with high spatial fidelity, enabling effective scene representation. Specifically, the at least one imaging processor optimizes image encoding by generating the first image of the first resolution through downscaling, and the second image of the second resolution by cropping the given portion of the at least one image corresponding to a region of interest. Moreover, the host device comprising the at least one first processor, further enhances real-time image processing by reconstructing the second chrominance planes of the second image. This is achieved by extracting the first chrominance planes from the first image and upscaling said first chrominance planes using the second luminance plane of the second image as a reference plane, thereby enabling high-resolution reconstruction of the second image without requiring redundant chrominance data transmission. It will be appreciated that the image processing system enhances system performance in latency-sensitive applications, such as in MR systems, AR systems, and similar. Furthermore, by offloading image processing from the host device to the at least one imaging processor, computational overhead at the host device is significantly reduced, enabling an efficient image reconstruction with minimal latency. Thus, the image processing system provides a structured approach to image compression and reconstruction, delivering an optimized balance between data reduction, transmission efficiency, and high-fidelity image rendering at the host device.

Throughout the present disclosure, the term “image data” refers to information pertaining to a given photo-sensitive cell of an image sensor, wherein said information comprises one or more of: a colour value of the given photo-sensitive cell, a transparency value of the given photo-sensitive cell, an illuminance value (namely, a luminance value or a brightness value) of the given photo-sensitive cell. The colour value could, for example, be Red-Green-Blue (RGB) values, Red-Green-Blue-Alpha (RGB-A) values, Cyan-Magenta-Yellow-Black (CMYK) values, Red-Green-Blue-Depth (RGB-D) values, or similar. The term “image processing system” refers to a system that captures, processes, analyses, and manipulates the image data to extract useful information, enhance visual representation, and/or enable further computational processing.

Throughout the present disclosure, the term “imaging processor” also known as an image signal processor (ISP) refers to a specialized processing unit configured to execute image processing tasks on a given image data or a given video data. The at least one imaging processor is designed to handle computationally intensive operations such as image acquisition, filtering, enhancement, noise reduction (i.e., chrominance noise reduction, luminance noise reduction), feature extraction, color space conversion, compression, object recognition, and similar. The at least one imaging processor is commonly employed in applications such as computer vision, AR, virtual reality (VR), medical imaging, machine learning-based image analysis, real-time video processing, and the like. In an implementation, the at least one imaging processor is communicably coupled with the at least one image source. The term “processor” refers to a computational element that is operable to execute the software framework. Examples of the processor may include, but are not limited to, a microprocessor, a microcontroller, a complex instruction set computing (CISC) microprocessor, a reduced instruction set computing (RISC) microprocessor, a very long instruction word (VLIW) microprocessor, digital signal processor (DSP), central processing unit (CPU), Field Programmable Gate Array (FPGA), or any other type of processing circuit.

Optionally, the image processing system is a video-pass-through (VPT) system. In this regard, the term “video-pass-through system” refers to a system configured to receive, process, and output video frames with minimal latency while preserving integrity of original video content. The VPT system typically performs real-time operations such as resolution upscaling, chrominance reconstruction, color space conversion, or enhancement without significantly altering temporal or spatial characteristics of video signal. The VPT system is commonly employed in applications such as AR, VR, MR, real-time video streaming, remote collaboration, medical imaging, and similar, where maintaining low-latency visual processing is essential to user experience and system performance. In other words, the VPT system is similar to a Video-See-Through (VST) system as both involve capturing real-world imagery using the one or more cameras, processing the image data, and displaying it on a given screen. A technical effect of implementing the aforesaid method in the VPT system is that it enables efficient real-time image processing while reducing bandwidth and computational load. The selective transmission and reconstruction of chrominance data lower data transfer requirements, thereby improving overall responsiveness and efficiency of said VPT system.

Throughout the present disclosure, the term “image source” refers to a hardware component configured to capture visual information from a given scene or an environment and generate corresponding image data. The term “image sensor” refers to a device that detects light from a real-world environment at a plurality of photo-sensitive cells (namely, a plurality of pixels) to capture a plurality of image signals. The plurality of image signals are electrical signals pertaining to a real-world scene of the real-world environment. The plurality of image signals constitute image data of the plurality of photo-sensitive cells. Examples of the image sensor may include, but are not limited to, a charge-coupled device (CCD) image sensor, and a complementary metal-oxide-semiconductor (CMOS) image sensor. Image sensors are well-known in the art. The term “pixel data” refers to information pertaining to a given pixel of a given region, wherein said information comprises one or more of: a colour value of the given pixel, a depth value of the given pixel, a transparency value of the given pixel, a luminance value of the given pixel, and the like. Optionally, the given pixel data is in a form of a RAW image data. Alternatively, optionally, the given pixel data is in a form of a given colour space data.

Herein, the at least one imaging processor receives the at least one image from the at least one image source in the image processing system by establishing a communication link with the at least one image source. For example, said communication link may include a wired interface or a wireless interface such as Mobile Industry Processor Interface (MIPI) Camera Serial Interface (CSI), Universal Serial Bus (USB), Ethernet, and the like, depending on architecture of the image processing system. The at least one image comprises the pixel data captured by the at least one image sensor of the at least one image source, wherein the pixel data may represent luminance, chrominance, and other image attributes based on spectral sensitivity of the at least one image sensor. Herein, the at least one image source comprises the one or more cameras with overlapping fields of view (FOV), enabling the at least one imaging processor to synchronize and aggregate multiple image streams for further processing. Herein, the at least one imaging processor may utilize timestamp synchronization, frame alignment techniques, and exposure control mechanisms to ensure consistency across the at least one image from the one or more cameras. Herein, in one case, when the at least one image is received from same camera, two outputs (i.e., the first image and the second image) can be generated by processing the at least one image captured by the camera. In another case, if images come from different cameras, two outputs (i.e., the first image and the second image) can be generated when the cameras have overlapping FOVs. For example, one camera could capture a wide-angle view (i.e., the first image), while another camera may capture a zoomed-in view (i.e., the second image) of the same region. It will be appreciated that inclusion of the one or more cameras with overlapping FOV allows for enhanced depth perception, multi-view fusion, and spatial awareness, which is beneficial for applications such AR, MR, three-dimensional (3D) scene reconstruction, and similar.

Throughout the present disclosure, the term “first image” refers to a full field of view image of the environment. The second image comprises a crop image corresponding to the portion of the first image. Herein, the at least one imaging processor performs downscaling on the at least one image using one or more known image resizing techniques, such as bilinear interpolation, bicubic interpolation, deep-learning-based super-resolution methods, and similar. The downscaling process ensures that the first image retains a structured representation of original scene while reducing its resolution. In this regard, the first luminance plane and the first chrominance planes are extracted from the downscaled image using a color space transformation, such as converting from red, green, blue, (RGB) to YUV, wherein Y represents luminance plane and UV represent chrominance planes. Herein, the luminance plane (i.e., Y-plane) comprises brightness information of the at least one image. The at least two given chrominance planes (i.e., U-plane and V-plane) comprise colour information of the at least one image. It will be appreciated that downscaling process optimizes bandwidth usage by reducing amount of data that needs to be transmitted.

Moreover, the at least one imaging processor identifies the region of interest within the at least one image based on predefined criteria, such as motion detection, edge detection, artificial intelligence-based object recognition, user input, and similar. The identified region is then cropped from the at least one image while preserving its native or near-native resolution, ensuring the second image retains higher detail. In this regard, the second luminance plane and the second chrominance planes are extracted from cropped region using a color space transformation. It will be appreciated that cropping a high-resolution region of interest allows for detailed processing of critical areas of the at least one image without need to transmit or store entire high-resolution image. A technical effect of generating the first image and the second image in such a manner is that it allows for efficient image processing, balancing computational efficiency with high-fidelity analysis, thereby improving real-time responsiveness in advanced imaging applications.

Optionally, at the step of processing the at least one image to generate the first image of the first resolution with the first luminance plane and the first chrominance planes, the method further comprises determining an average of the pixel data of a given set of pixels from the at least one image sensor to create each pixel of the first image. In this regard, the at least one image sensor captures raw pixel data in a Bayer pattern, where each 2×2 pixel block consists of one red (R), two green (G), and one blue (B) pixel. This arrangement allows the at least one image sensor to capture intensity variations for different wavelengths of light, prioritizing green pixels due to human visual sensitivity to green. However, raw Bayer-data does not contain full-color information for each pixel, as each pixel only detects a single color channel. To generate a lower-resolution first image, the at least one imaging processor performs pixel averaging over a predefined set of pixels from the at least one image sensor. A group of adjacent pixels (e.g., 2×2, 3×3, or more, depending on desired scaling factor) is processed to compute an average value, which forms a single pixel in the downscaled image. This averaging operation smooths out local variations and reduces random noise in the at least one image. The averaging function may be implemented using techniques such as Box filtering (i.e., a straightforward average of the pixel values), Gaussian filtering (i.e., a weighted average where central pixels contribute more than peripheral ones), and similar. After downscaling, the Bayer pattern remains, but at a lower resolution. Next, the at least one imaging processor may perform demosaicing, where missing color values for each pixel are interpolated to construct a full RGB image. This demosaicing operation can be performed using algorithms such as bilinear interpolation, edge-aware interpolation, deep-learning-based techniques, and similar, to reconstruct high-quality RGB data. Once RGB image is constructed, the at least one imaging processor then converts the RGB image into YUV color space. This conversion may be performed using standard transformation matrices, ensuring efficient encoding of color information.

It will be appreciated that performing pixel averaging during the downscaling process reduces overall data volume while preserving essential scene structures. This leads to more efficient storage and transmission, particularly in bandwidth-constrained environments such as real-time video streaming and embedded imaging applications. It will also be appreciated that averaging the pixel data helps in reducing sensor noise, as random noise components tend to cancel out during the averaging process. This results in a cleaner, more stable first image, which is particularly beneficial for low-light imaging and high dynamic range (HDR) applications. A technical effect of the aforementioned feature is that it optimizes data processing efficiency by reducing resolution while preserving essential image details, thereby enabling lower bandwidth usage and faster computational processing.

Optionally, the first resolution of the first image comprises a first sub-resolution and a second sub-resolution, wherein the first sub-resolution of the first chrominance planes corresponds to the second resolution of the second luminance plane of the second image in the given portion, and the second sub-resolution is down-sampled in a predefined range with respect to the first resolution. In this regard, the term “first sub-resolution” refers to a subdivision of the first resolution in which the first chrominance planes are maintained at a resolution corresponding to the second resolution of the second luminance plane in the given portion of the image. This ensures that color information is preserved at a level matching the detailed luminance data in the region of interest, optimizing visual fidelity and color accuracy. Moreover, the term “second sub-resolution” refers to a further down-sampled version of the first resolution, where the level of down-sampling falls within the predefined range. This reduction in resolution is applied to optimize data storage, transmission, and processing efficiency while maintaining a structured representation of original scene.

Herein, the at least one image is downscaled to generate the first image at the first resolution using known image resizing techniques such as bilinear interpolation, bicubic interpolation, deep-learning-based super-resolution, and similar. During this downscaling process, the first chrominance planes are stored at the first sub-resolution, which is set to match the second resolution of the second luminance plane in the cropped portion of the second image. This alignment ensures that when the second image is extracted, it retains high-fidelity chrominance data, enabling accurate color representation. Moreover, the second sub-resolution is obtained by down-sampling the first resolution within the predefined range, ensuring a balance between resolution reduction and visual quality retention. After the first image is generated, an RGB-to-YUV color space conversion is performed, wherein the first chrominance planes are processed separately to ensure that the first sub-resolution corresponds to detailed luminance portion of the second image. It will be appreciated that structuring the first resolution into the first sub-resolution and the second sub-resolution, optimizes data storage and transmission by selectively allocating higher resolution to critical visual regions while reducing unnecessary data for less significant areas. It will also be appreciated that aligning the first sub-resolution of the first chrominance planes with the second resolution of the second luminance plane ensures accurate color representation in the region of interest, thereby enhancing visual fidelity without excessive data overhead. Furthermore, it will be appreciated that down-sampling the second sub-resolution within the predefined range balances computational efficiency and image quality, allowing for efficient processing while maintaining perceptual clarity in relevant areas.

A technical effect of the aforementioned feature is that it optimizes image storage and transmission by selectively maintaining high-resolution chrominance data for critical areas while efficiently down-sampling less essential regions, thereby reducing bandwidth and computational load while preserving high-fidelity color information where needed.

Optionally, the first chrominance planes are downscaled to a resolution less than a resolution of the first luminance plane, and the second chrominance planes of the second image are downscaled to a resolution that is greater than the resolution of the first chrominance planes. In this regard, the at least one image sensor captures the at least one image at an initial resolution, where the first image is generated with the first luminance plane and the first chrominance planes. The first luminance plane is retained at a higher resolution to preserve fine details, as human vision is more sensitive to brightness variations than color differences. Herein, the first chrominance planes are downscaled by the at least one imaging processor to a resolution lower than the first luminance plane. It will be appreciated that the reduction in chrominance resolution minimizes storage and processing requirements while maintaining sufficient color information for accurate visual representation. Moreover, as the second image is extracted as a cropped region of interest from the at least one image, corresponding to a higher resolution than the first chrominance planes. The second luminance plane retains fine details to ensure high-quality grayscale structure in the region of interest. Herein, the second chrominance planes are downscaled by the at least one imaging processor to a resolution higher than the first chrominance planes. This ensures that the chrominance information for the region of interest has greater detail than general chrominance data in the first image. Optionally, the downscaling of the second chrominance planes may be performed in a predefined range to balance color fidelity with efficient data representation.

For example, consider an image processing system where the at least one image may be captured by the at least one image sensor at an initial resolution of 1920×1080 pixels. The at least one imaging processor may process the captured image to generate two different representations, a first image (i.e., a context image) and a second image (i.e., a focus/gaze area image). Herein, the first image may be generated by the at least one imaging processor by downscaling the at least one image to 480×270 pixels, which is a quarter of the resolution of the at least one image. In this regard, the luminance plane of the first image may be retained at the full resolution of 480×270 pixels to preserve structural details. The chrominance planes are downsampled further to 240×135 pixels, which is half the resolution of the luminance plane. It will be appreciated that such an approach of downsampling reduces size of chrominance data, thereby saving bandwidth.

Moreover, the second image may be obtained by cropping a region of interest from the at least one image, resulting in a resolution of 960×540 pixels (i.e., half the resolution of the at least one image). The luminance plane of the second image retains the full resolution of 960×540 pixels to maintain fine details within the region of interest. The chrominance planes are downsampled to 480×270 pixels, which is half the resolution of the second luminance plane. It will be appreciated that such an approach ensures better color fidelity in the region of interest by maintaining a higher chrominance resolution than in the first image while optimizing overall data efficiency.

A technical effect of the aforementioned feature is that it enhances image processing efficiency by selectively reducing chrominance data in regions where high color fidelity is less perceptually significant while preserving finer chrominance details in essential regions. This optimization reduces bandwidth, storage requirements, and computational load, thereby improving overall efficiency of the image processing system without compromising visual quality in essential regions.

Optionally, the first resolution lies in a range of 2 times the second resolution to a value proportional to a total number of pixels in the at least one image, times the second resolution. In this regard, the at least one image is captured at an initial resolution by the at least one image sensor. The at least one imaging processor processes the at least one image to generate the first image at the first resolution, which lies in the range of 2 times the second resolution of the second image. The first resolution may also scale up proportionally based on the total pixel count of the at least one image, ensuring adaptability depending on available pixel data. The first image is then processed to extract the first luminance plane and the first chrominance planes, while the second image is obtained by cropping a region of interest at the second resolution. This ensures that the second image retains finer details while the first image provides a contextual overview of an entire scene. The most common ratios between the first resolution and the second resolution typically range from 2:1 to 4:1. However, in an extreme case, the ratio may be such that the first resolution corresponds to the resolution of the luminance plane, where a single U and V chrominance value is provided for the entire image. This approach significantly reduces chrominance data storage and processing requirements while preserving luminance details in the second image. It will be appreciated that defining the first resolution in relation to the second resolution and the total pixel count allows for adaptive scaling, ensuring an optimal balance between spatial resolution and computational efficiency. It will also be appreciated that maintaining a defined ratio between the first resolution and the second resolution enables consistent color accuracy and structural integrity in the processed image, particularly when extracting the region of interest.

For example, consider an image processing system, where the at least one image sensor may capture the at least one image at an initial resolution of 8000×6000 pixels (i.e., 48 megapixels). The at least one imaging processor may process the captured image to generate the first image at a first resolution. Since, the first resolution lies in the range of 2 times the second resolution to a proportional value determined by the total pixel count. In this regard, the second resolution may be chosen as 2000×1500 pixels (i.e., 3 megapixels), which corresponds to the resolution of the second image (a cropped region of interest). Thus, the first resolution may be selected to be 4000×3000 pixels (i.e., 12 megapixels), which is 2 times the second resolution and lies within the defined range. Additionally, if a higher first resolution may be needed for contextual integrity, it may be determined based on a proportional value relative to the total pixel count of 48 megapixels, resulting in a resolution such as 6000×4500 pixels (i.e., 27 megapixels).

A technical effect of the aforementioned feature is that it enables dynamic resolution scaling, optimizing image processing efficiency while preserving high-detail information in the region of interest. This improves storage efficiency, computational performance, and bandwidth usage while ensuring accurate visual representation for applications such as AR/MR, medical imaging, and the like.

Throughout the present disclosure, the term “host device” refers to a computing system, a processing unit, and/or an external system that receives and processes the image data transmitted from the at least one imaging processor. The host device may include, but are not limited to, a computer, a server, a mobile device, an embedded system, and a hardware module configured to perform operations such as image reconstruction, analysis, display, storage, and similar. Notably, the host device comprises the at least one first processor. Herein, the at least one imaging processor is configured to separate the second luminance plane from the second chrominance planes. The separation may involve decoding or processing the image data in a format such as YUV, where the luminance (Y) and chrominance (U, V) components are stored separately. In this regard, the at least one imaging processor extracts only the second luminance plane from the second image while omitting the second chrominance planes. The omission of the second chrominance planes during transmission is achieved by discarding or not encoding the chrominance data for the second image before sending the data to the host device. A technical effect of separating the second luminance plane from the second chrominance planes of the second image is that it reduces the amount of data transmitted to the host device, thereby optimizing bandwidth usage and lowering storage requirements. Such an approach ensures that luminance information, which is more essential for visual perception and image analysis, is preserved while unnecessary chrominance data is omitted. Additionally, it enables efficient image processing by allowing the host device to selectively reconstruct or enhance color information as needed, improving overall performance and adaptability of the image processing system.

Throughout the present disclosure, the at least one imaging processor is configured to transmit the first image (i.e., with luminance and chrominance planes) and the second image (i.e., with only the luminance plane) to the host device using a data transmission interface (described later). The transmission can be carried out via various wired or wireless communication networks, depending on requirements of the image processing system. For example, the at least one imaging processor may utilize wired interfaces such as USB Interface, MIPI CSI Interface, Ethernet, and the like. Similarly, the at least one imaging processor may utilize wireless interfaces such as Wireless Fidelity (Wi-fi), Bluetooth, cellular communication, and the like. It will be appreciated that transmitting the first image with the first luminance plane and the first chrominance planes ensures that full color information is retained for comprehensive image representation, thereby maintaining high image fidelity for regions where detailed color accuracy is important. This is particularly beneficial for image reconstruction, display, or further processing that requires full chrominance data. Additionally, it will be appreciated that transmitting the second image with only the second luminance plane reduces the amount of data transmitted, thereby optimizing bandwidth and computational efficiency. Since the human visual system is more sensitive to luminance variations than chrominance details, omitting the second chrominance planes results in minimal perceptual loss while significantly reducing storage and processing requirements on the host device.

Next, at the host device, the first image with the first luminance plane and the first chrominance planes, and the second image with the second luminance plane is received via the data transmission interface. The communication protocol ensures data integrity and synchronization between the at least one imaging processor and the host device. Upon receiving the image data, the at least one first processor of the host device processes the first image by extracting the first luminance plane and the first chrominance planes and storing them in an appropriate format, such as YUV, RGB, or another color encoding scheme. The first image serves as the context image, providing full-color scene information. Simultaneously, the second image is received with only the second luminance plane, while the second chrominance planes are omitted. The second luminance plane may be stored separately and may be used for high-precision image processing tasks such as object recognition, feature detection, image enhancement, and the like. Once both images are received, the at least one first processor of the host device may apply post-processing operations such as image fusion, contrast enhancement, edge detection, and similar, to enhance visual quality and extract information.

Next, at the host device, the at least one first processor reconstructs the second chrominance planes for the second image by leveraging the chrominance information from the first image. The at least one first processor retrieves the first chrominance planes from the first image that was received via the communication network. These chrominance planes represent color difference components of the first image in a format such as YUV, or similar color encoding schemes. Moreover, the second luminance plane, corresponding to the second image, serves as the reference plane for reconstructing chrominance data. Since chrominance defines color variation but does not impact brightness, aligning the chrominance data with new luminance structure ensures spatial accuracy and color consistency in reconstructed image. Typically, due to chroma subsampling the first chrominance planes are at a lower resolution than the second luminance plane. In this regard, the at least one first processor may apply an upscaling algorithm to match resolution and spatial properties of the second luminance plane. After upscaling, the upscaled chrominance planes are aligned with the second luminance plane. The reconstructed image may be then stored or processed in a standard format such as YUV, and the like, depending on the system requirements. Additional post-processing steps, such as color correction, noise reduction, or sharpening, may be applied to enhance quality. A technical effect of such an approach is that it reduces data transmission overhead while maintaining perceptual image quality. It will be appreciated that upscaling process ensures that reconstructed chrominance planes align with high-resolution luminance details, thereby preserving color fidelity and spatial accuracy. Additionally, this method enhances computational efficiency by minimizing need for redundant chrominance encoding and transmission, making it particularly advantageous for resource-constrained imaging applications such as real-time video processing, computer vision, low-power imaging systems, and the like.

Optionally, the step of reconstructing the second chrominance planes for the second image comprises employing at least one upscaling algorithm by the host device. In this regard, the term “upscaling algorithm” refers to a computational method used to increase spatial resolution of an image or specific image components, such as chrominance planes, by generating additional pixel data based on existing lower-resolution information. The at least one upscaling algorithm interpolates or predicts missing details to enhance image quality while maintaining structural integrity and minimizing visual artifacts (such as blurring, aliasing, color distortions, and the like). Herein, at the host device, the at least one first processor is configured to employ the at least one upscaling algorithm to the first chrominance planes extracted from the first image. The upscaling process increases resolution of the chrominance data to match that of the second luminance plane. The upscaled chrominance planes are then merged with the second luminance plane to reconstruct final second image. A technical effect of employing the at least one upscaling algorithm is that it enhances visual quality of reconstructed image while minimizing data transmission requirements. By transmitting only the second luminance plane and reconstructing chrominance data through upscaling, the method optimizes bandwidth usage and reduces storage overhead.

Optionally, the at least one upscaling algorithm comprises at least one of: an edge-aware upscaling algorithm, an interpolation-based upscaling algorithm, a machine learning-based upscaling algorithm, a bilateral filtering technique, a frequency-domain upscaling algorithm, a neural network-based upscaling algorithm.

In this regard, the term “edge-aware upscaling algorithm” is an image enhancement technique that increases the resolution of an image while preserving sharpness at high-contrast edges. The edge-aware upscaling algorithm analyses gradient information or edge structures within the at least one image to prevent artifacts such as blurring or halo effects. Common edge-aware upscaling methods include guided image filtering and anisotropic diffusion-based upscaling. Moreover, the term “interpolation-based upscaling algorithm” is a mathematical technique that estimates new pixel values in an upscaled image by computing intermediate values based on existing neighboring pixels. Examples of the interpolation-based upscaling algorithm may include, but are not limited to, bilinear interpolation, bicubic interpolation, and Lanczos resampling, each of which applies different weighting functions to generate smooth transitions between pixels while minimizing visual distortions. Moreover, the term “machine learning-based upscaling algorithm” is an image resolution enhancement method that utilizes trained models to predict high-resolution image details from low-resolution inputs. These models are trained on large datasets to learn complex mapping functions that enhance image sharpness, reduce noise, and reconstruct fine details. Such algorithms may employ techniques like decision trees, support vector machines, or reinforcement learning. Moreover, the term “bilateral filtering technique” is a noise-reducing and edge-preserving filtering method used in image processing. The bilateral filtering technique applies a weighted averaging function where pixel weights are determined by both spatial proximity and intensity similarity. This allows smooth regions to be upscaled without introducing noise, while preserving edge details and minimizing over-smoothing artifacts. Moreover, the term “frequency-domain upscaling algorithm” is an image resolution enhancement technique that operates in the frequency domain rather than the spatial domain. It utilizes transforms such as the Fourier Transform or Wavelet Transform to analyse and manipulate frequency components of an image. High-frequency details, which contain texture and edges, are selectively enhanced or reconstructed to achieve higher-resolution outputs. Moreover, the term “neural network-based upscaling algorithm” is a deep learning-based image super-resolution technique that employs artificial neural networks, such as convolutional neural networks (CNNs) or generative adversarial networks (GANs), to reconstruct high-resolution images from low-resolution inputs. The neural network-based upscaling algorithm is trained on high-quality images and learns to generate realistic details, reduce noise, and enhance textures with high accuracy. Optionally, the at least one upscaling algorithm comprises a guided image upscaling technique. Herein, the term “guided image upscaling technique” refers to an upscaling technique that utilizes structural information from a high-resolution guidance image, such as the second luminance plane, to enhance resolution of a lower-resolution image, such as the first chrominance planes, while preserving edges, textures, and spatial consistency. In an implementation, optionally, the at least one first processor may apply the guided image upscaling technique to refine the first chrominance planes, wherein the second luminance plane serves as the reference plane for the upscaling process. By leveraging high-frequency details of the second luminance plane, the guided image upscaling technique ensures that the first chrominance planes maintain spatial consistency with the second luminance plane. The aforesaid types of the at least one upscaling algorithm are well-known in the art.

A technical effect of employing the at least one of the aforesaid upscaling algorithms is that it enables efficient and high-quality reconstruction of the second chrominance planes while maintaining spatial accuracy and reducing artifacts. Additionally, it will be appreciated that selecting an appropriate upscaling algorithm based on requirements of the image processing system optimizes computational efficiency, thereby reducing bandwidth consumption and improving overall image fidelity. This is particularly beneficial in applications such as image enhancement, object recognition, display processing, and real-time video streaming, where maintaining high-quality visual output with minimal computational overhead is essential.

Throughout the present disclosure, at the host device, the at least one first processor reconstructs the second image of the second resolution by combining the reconstructed second chrominance planes with the second luminance plane. This reconstruction process ensures that the second image is restored in a complete color format suitable for display, storage, or processing. It is to be understood that the host device has retrieved the second luminance plane, via the data transmission interface. Simultaneously, the at least one first processor of the host device accesses the reconstructed second chrominance planes, which were derived from the first chrominance planes of the first image and upscaled to align with spatial resolution of the second luminance plane. Once the reconstructed second chrominance planes and the second luminance plane are available, the at least one first processor is configured to merge the second luminance plane with the reconstructed second chrominance planes. This merging process may involve color space reconstruction techniques depending on the format used. For example, if images may be represented in YUV color space, the at least one first processor may combine Y component with U and V components to form a complete YUV image. Moreover, to ensure spatial consistency, the at least one first processor may perform additional operations such as edge alignment, contrast adjustment, and noise reduction to minimize artifacts introduced during chrominance upscaling. This reconstruction process ensures that the second image maintains high visual quality while optimizing computational efficiency, bandwidth usage, and storage requirements in the image processing system.

Optionally, the method further comprising replacing the first chrominance planes of the first image with the second chrominance planes of the second image in the given portion of the second image, wherein the given portion overlaps with a corresponding portion of the first image that is in a field of view of the one or more cameras, and wherein the second chrominance planes are aligned with the first luminance plane of the first image in the given portion. In this regard, the at least one imaging processor may first determine overlapping region between the first image and the second image within the FOV of the one or more cameras. This determination may be achieved by analysing the image data, utilizing positional tracking information, or performing direct pixel-based comparisons. Since, the first image consists of the first luminance plane and the first chrominance planes, while the second image consists of the second luminance plane and the second chrominance planes. The at least one imaging processor retrieves the second chrominance planes from the second image and isolates the first luminance plane from the first image within the given portion. In this regard, the at least one imaging processor replaces the first chrominance planes of the first image with the second chrominance planes of the second image within the given portion. This ensures that updated image contains chrominance information from the second image while maintaining luminance data of the first image in the given portion. To maintain spatial consistency, the at least one imaging processor may perform alignment operations to ensure that the second chrominance planes correspond spatially to the first luminance plane in the given portion. This may involve resampling techniques to adjust chrominance resolution if needed, geometric transformation operations to match pixel positions, edge-aware processing to minimize misalignment artifacts, and similar.

It will be appreciated that replacing the first chrominance planes of the first image with the second chrominance planes of the second image in the given portion enables enhanced color accuracy while preserving original luminance details, thereby improving overall image quality without introducing significant computational overhead. It will also be appreciated that aligning the second chrominance planes with the first luminance plane in the given portion ensures spatial consistency, reducing potential color misalignment artifacts that may arise from differences in resolution or sampling between the first image and the second image. A technical effect of the aforementioned feature is that it enables seamless integration of chrominance information from the second image while preserving luminance details from the first image, thereby enhancing color accuracy and spatial consistency. Such an approach optimizes image reconstruction efficiency, reduces computational overhead, and improves overall visual fidelity in real-time image processing applications.

Optionally, the method further comprising:
determining gaze directions of user's eyes;
determining a gaze area, based on the gaze directions of the user's eyes; and
determining the given portion of the first image, based on the gaze area.

In this regard, the term “gaze direction” refers to a direction in which the user's eye is gazing. The gaze direction may be represented by a gaze vector. Optionally, when processing gaze-tracking data, the at least one imaging processor is configured to employ at least one of: an image processing algorithm, a feature extraction algorithm, a data processing algorithm. Other suitable algorithm(s) can also be employed. In an implementation, a gaze-tracker may be used to determine the gaze direction. Notably, the term “gaze-tracker” refers to a device, or a sensor-based mechanism configured to detect and track movement and orientation of the user's eyes to determine their gaze direction. The gaze-tracker may utilize one or more infrared cameras, near-infrared light sources, optical sensors, or image-processing algorithms to capture eye movement data and compute a point of regard within a given visual scene. Moreover, the term “gaze area” refers to a defined spatial region within the at least one image that corresponds to the user's visual focus, as determined based on the gaze direction. The gaze area may be dynamically adjusted based on fixation points, saccadic movements, or head pose estimation. The gaze area may be represented as a two-dimensional region or a three-dimensional region and is used in image processing applications to prioritize rendering, enhancement, or reconstruction operations in areas where the user is actively looking.

In the image processing system, optionally, the gaze-tracker is communicably coupled to the at least one imaging processor. Herein, the gaze-tracker captures the movements of the user's eyes and may transmit said information to the at least one imaging processor. In this regard, the at least one imaging processor may determine the gaze directions of the user's eyes in real time. Using the gaze directions, the gaze area may be determined, which represents specific region of a given scene where the user's focus is directed. The gaze area may be determined using gaze fixation points, head pose estimation, or predictive models of visual attention. In this regard, the gaze area is used to identify the given portion of the first image for processing. Such determination may involve mapping the gaze area to coordinates of the first image (i.e., the at least one imaging processor may align the gaze area with spatial layout of the first image), extracting the given portion (i.e., the overlapping region between the gaze area and the first image may be identified as the given portion), and similar. Optionally, the given portion may be pixel-level selection based on exact mapped coordinates, region-based selection to account for processing optimizations (e.g., selecting a larger portion for pre-emptive processing), and similar. Depending on function of the image processing system, the given portion of the first image may be prioritized for higher resolution rendering, color correction, or other enhancements to optimize visual quality in the user's gaze area. Optionally, in addition to gaze-based positioning for determining the given portion of the first image, the given portion may also be positioned based on other points of interest, such as the user's hands, a specific region within the given scene, and the like. Alternatively, optionally, the given portion may be statically placed at a predefined location, such as in the center of the FOV. The selection of the given portion may be dynamically adjusted based on contextual information, object tracking, or predefined system parameters to optimize image processing operations.

It will be appreciated that determining the gaze directions of the user's eyes enables real-time identification of the user's visual focus, allowing the method to process only the given portion of the first image, thereby optimizing computational efficiency. It will also be appreciated that dynamically determining the gaze area based on the gaze directions enhances responsiveness in interactive visual applications, ensuring that high-fidelity rendering and image enhancements are applied only where necessary. A technical effect of the aforementioned feature is that it enables adaptive and user-centric image processing by prioritizing regions based on real-time gaze tracking. Such an approach enhances visual perception, reduces unnecessary computational load, and optimizes bandwidth usage, thereby improving efficiency and responsiveness of the image processing system in real-time applications such as in AR, VR, MR, and similar.

Optionally, the method further comprising employing a data transmission interface to transmit to the host device, the first image with the first luminance plane and the first chrominance planes, and the second image with the second luminance plane. In this regard, the term “data transmission interface” refers to a hardware communication interface and/or a software communication interface that facilitates transfer of the image data between the at least one imaging processor to the host device. The data transmission interface may employ various transmission standards such as USB, Peripheral Component Interconnect express (PCIe), High-Definition Multimedia Interface (HDMI), DisplayPort, Ethernet, Wi-Fi, Bluetooth, cellular communication, and similar. In some implementations, the at least one imaging processor may transmit the first image with the first luminance plane and the first chrominance planes, and the second image with the second luminance plane to the host device via the USB.

A technical effect of employing the data transmission interface is that it enables efficient and reliable transfer of the image data from the at least one imaging processor to the host device, ensuring minimal latency and data integrity during transmission. It will also be appreciated that the use of standardized communication protocols allows for seamless integration with various host devices, thereby enhancing compatibility and scalability of the image processing system.

The present disclosure also relates to the aforementioned second aspect as described above. Various embodiments and variants disclosed above, with respect to the aforementioned first aspect, apply mutatis mutandis to the aforementioned second aspect.

Optionally, the at least one imaging processor is further configured to replace the first chrominance planes of the first image with the second chrominance planes of the second image in the given portion of the second image, wherein the given portion overlaps with a corresponding portion of the first image that is in a field of view of the one or more cameras, and wherein the second chrominance planes are aligned with the first luminance plane of the first image in the given portion.

Optionally, the image processing system further comprises a gaze-tracker, wherein the at least one imaging processor is further configured to:
determine gaze directions of user's eyes;
determine a gaze area, based on the gaze directions of the user's eyes; and
determine the given portion of the first image, based on the gaze area.

Optionally, the at least one imaging processor is further configured to transmit the first image with the first luminance plane and the first chrominance planes, and the second image with the second luminance plane to the host device via a data transmission interface.

### EXPERIMENTAL PART

In an exemplary implementation, consider an image processing system, operating at 90 Hertz (Hz), wherein an image data may be transmitted using YUV420 format at a resolution of 832×640 pixels for both the first image (i.e., downscaled image) and the second image (i.e., cropped image). Herein, a bandwidth consumption before applying the aforesaid method was calculated as explained below:

For the first image stream;

$$Y - plane in Megabits per second ( Mbps ) = resolution \times bits \times frames per second ;$$

$$Y - plane = ( 832 \times 640 ) \times 8 \times 90 = 383 Mbps .$$

Similarly, UV-plane in Mbps=resolution×bits×frames per second;

$$UV - plane = ( 832 \times 640 ) \times 4 \times 90 = 192 Mbps .$$

Subsequently, for the second image stream;

$$Y - plane in Mbps = resolution \times bits \times frames per second ;$$

$$Y - plane = ( 832 \times 640 ) \times 8 \times 90 = 383 Mbps .$$

Similarly, UV-plane in Mbps=resolution×bits×frames per second;

$$UV - plane = ( 832 \times 640 ) \times 4 \times 90 = 192 Mbps .$$

Therefore, for both left eye and right eye of a given user, the total bandwidth consumption (i.e., before applying the aforesaid method) may be given by an equation (1);

$$Total bandwidth consumption = ( first image + second image ) \times 2 ( i . e . , left eye and right eye ) \qquad ( 1 )$$

$$Total bandwidth consumption = ( 383 + 192 ) + ( 383 + 192 ) \times 2$$

$$Total bandwidth consumption = 2300 Mbps .$$

Moreover, by employing the aforesaid method, the second image stream may reuse chrominance (UV) data from the first image, eliminating need to transmit an additional UV-plane for the second image. The new bandwidth calculation may be as explained below:

For the first image stream:

$$Y - plane in Mbps = resolution \times bits \times frames per second ;$$

$$Y - plane = ( 832 \times 640 ) \times 8 \times 90 = 383 Mbps .$$

Similarly, UV-plane in Mbps=resolution×bits×frames per second;

$$UV - plane = ( 832 \times 640 ) \times 4 \times 90 = 192 Mbps .$$

Subsequently, for the second image stream,

$$Y - plane in Mbps = resolution \times bits \times frames per second ;$$

$$Y - plane = ( 832 \times 640 ) \times 8 \times 90 = 383 Mbps .$$

Therefore, for both the left eye and the right eye of the given user, the total bandwidth consumption may be determined by using equation (1);

$$Total bandwidth consumption = \{ ( 383 + 192 ) + ( 383 ) \} \times 2 ;$$

$$Total bandwidth consumption = 1916 Mbps .$$

Thus, the aforesaid method results in a bandwidth reduction of 17 percent, reducing bandwidth consumption from 2300 Mbps to 1916 Mbps. This optimization allows for practical improvements, such as increasing resolution of the second image. For example, the resolution of the second image may increase from 832×640 pixels (i.e., FOV may be 16.3°×12.5°) to 992×928 pixels (i.e., FOV may be 19.5°×18.2°), thereby enhancing visual clarity in focus areas without increasing transmission requirements.

### DETAILED DESCRIPTION OF THE DRAWINGS

Referring to FIG. 1, illustrated are steps of a method for processing and transferring image data in an image processing system, in accordance with an embodiment of the present disclosure. At step 102, at least one image is received from at least one image source comprised in the image processing system, wherein the at least one image comprises pixel data from at least one image sensor of the at least one image source, and wherein the at least one image source comprises one or more cameras with overlapping fields of view. At step 104, at least one image is processed to generate: a first image of a first resolution by downscaling the at least one image, wherein the first image comprises a first luminance plane and first chrominance planes; and a second image is processed to generate a second image of a second resolution by cropping a given portion of the at least one image corresponding to a region of interest, comprising a second luminance plane and second chrominance planes, wherein the second resolution is greater than the first resolution. At step 106, the second luminance plane is separated from the second chrominance planes of the second image, wherein the second chrominance planes are omitted during transmission to a host device. At step 108, the first image with the first luminance plane and the first chrominance planes, and the second image with the second luminance plane, are transmitted to a host device comprised in the image processing system. At step 110, the first image with the first luminance plane and the first chrominance planes, and the second image with the second luminance plane, are received at the host device. At step 112, the second chrominance planes for the second image are reconstructed, by extracting the first chrominance planes from the first image and upscaling said first chrominance planes of the first image using the second luminance plane of the second image as a reference plane. At step 114, the second image of the second resolution is reconstructed at the host device, based on the reconstructed second chrominance planes and the second luminance plane.

The aforementioned steps are only illustrative and other alternatives can also be provided where one or more steps are added, one or more steps are removed, or one or more steps are provided in a different sequence without departing from the scope of the claims herein.

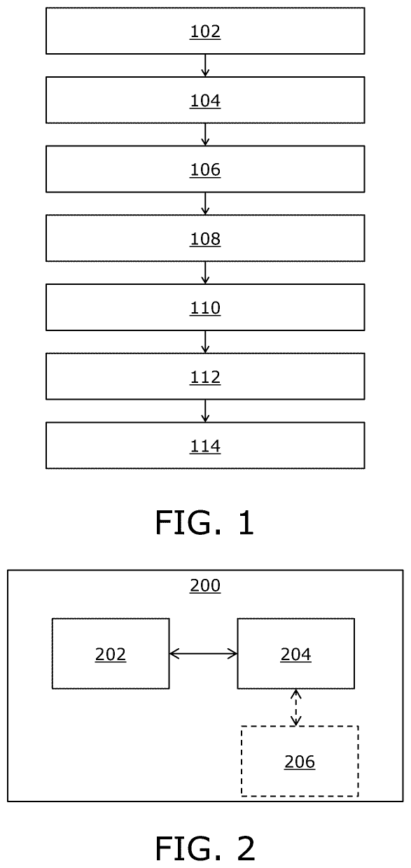

Referring to FIG. 2, there is illustrated a block diagram of an image processing system 200, in accordance with an embodiment of the present disclosure. The image processing system 200 comprises at least one image source (depicted as an image source 202), and at least one imaging processor (depicted as an imaging processor 204) that is communicably coupled with the image source 202. The imaging processor 204 is configured to perform various operations, as described earlier with respect to the aforementioned second aspect. Optionally, the image processing system comprises a gaze-tracker 206. The imaging processor 204 is communicably coupled to the image source 202 and optionally to the gaze-tracker 206.

FIG. 2 is merely an example, which should not unduly limit the scope of the claims herein. A person skilled in the art will recognize many variations, alternatives, and modifications of embodiments of the present disclosure.

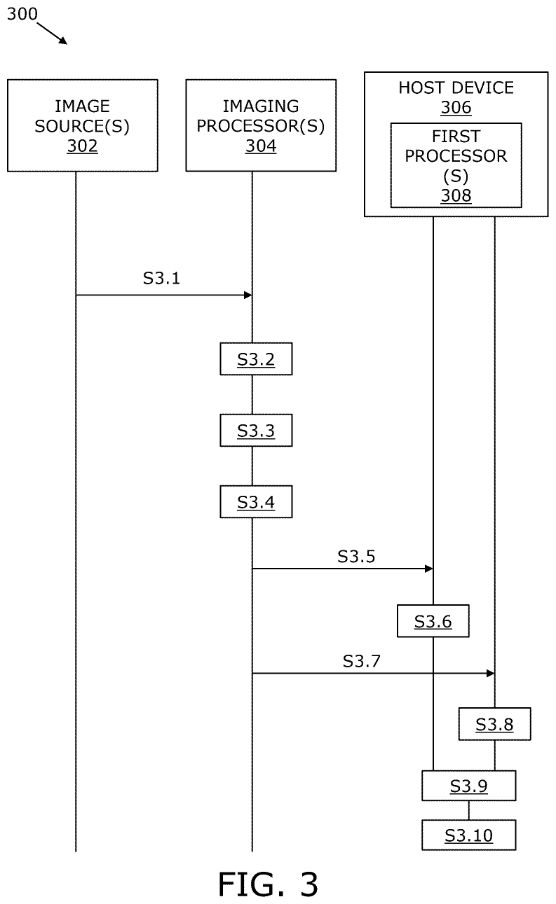

Referring to FIG. 3, illustrated is an exemplary process flow for processing and transferring an image data in an image processing system 300, in accordance with an embodiment of the present disclosure. Herein, the image processing system comprises at least one image source (depicted as an image source 302), and at least one imaging processor (depicted as an imaging processor 304). There is shown a host device 306, wherein said host device 306 comprises at least one first processor (depicted as a first processor 308).

As shown, at S3.1, the imaging processor 304 is configured to receive at least one image from the image source 302. At S3.2, the imaging processor 304 processes the at least one image to generate: a first image of a first resolution by downscaling the at least one image, wherein the first image comprises a first luminance plane (i.e., Y plane) and first chrominance planes (i.e., UV planes). At S3.3, the imaging processor 304 generates a second image of a second resolution by cropping a given portion of the at least one image corresponding to a region of interest, comprises a second luminance plane and second chrominance planes, wherein the second resolution is greater than the first resolution. At S3.4, the imaging processor 304 separates the second luminance plane from the second chrominance planes of the second image, wherein the second chrominance planes are omitted during transmission to the host device 306. At S3.5, the imaging processor 304 transmits to the host device 306, the first image with the first luminance plane and the first chrominance planes, via a data transmission interface, for example, via a Universal Serial Bus (USB) (not shown for the sake of clarity). At S3.6, at the host device 306, the first processor 308 receives from the imaging processor 304, the first image with the first luminance plane and the first chrominance planes. At S3.7, the imaging processor 304 transmits to the host device 306, the second image with the second luminance plane via the data transmission interface, for example, via the USB. At S3.8, at the host device 306, the first processor 308 receives from the imaging processor 304, the second image with the second luminance plane. Alternatively, optionally, the imaging processor 304 may transmit (not shown for the sake of clarity), the first image with the first luminance plane and the first chrominance planes, and the second image with the second luminance plane, simultaneously to the host device 306 via the data transmission interface. Alternatively, optionally, at the host device 306, the first processor 308 may receive (not shown for the sake of clarity), the first image with the first luminance plane and the first chrominance planes, and the second image with the second luminance plane, simultaneously from the imaging processor 304 via the data transmission interface. At S3.9, the first processor 308 of the host device 306 reconstructs the second chrominance planes for the second image, by extracting the first chrominance planes from the first image and upscaling said first chrominance planes of the first image using the second luminance plane of the second image as a reference plane. At S3.10, the first processor 308 reconstructs the second image of the second resolution, based on the reconstructed second chrominance planes and the second luminance plane.

FIG. 3 is merely an example, which should not unduly limit the scope of the claims herein. A person skilled in the art will recognize many variations, alternatives, and modifications of embodiments of the present disclosure.

1. A method for processing and transferring image data in an image processing system, the method comprising:
receiving, at least one image from at least one image source comprised in the image processing system, wherein the at least one image comprises pixel data from at least one image sensor of the at least one image source, and wherein the at least one image source comprises one or more cameras with overlapping fields of view;
processing the at least one image to generate:
a first image of a first resolution by downscaling the at least one image, wherein the first image comprises a first luminance plane and first chrominance planes; and
a second image of a second resolution by cropping a given portion of the at least one image corresponding to a region of interest, comprising a second luminance plane and second chrominance planes, wherein the second resolution is greater than the first resolution;
separating the second luminance plane from the second chrominance planes of the second image, wherein the second chrominance planes are omitted during transmission to a host device;
transmitting, to the host device comprised in the image processing system:
the first image with the first luminance plane and the first chrominance planes, and
the second image with the second luminance plane;
receiving, at the host device:
the first image with the first luminance plane and the first chrominance planes, and
the second image with the second luminance plane;
reconstructing the second chrominance planes for the second image, by extracting the first chrominance planes from the first image and upscaling said first chrominance planes of the first image using the second luminance plane of the second image as a reference plane; and
reconstructing, at the host device, the second image of the second resolution, based on the reconstructed second chrominance planes and the second luminance plane.

2. The method of claim 1, wherein the step of reconstructing the second chrominance planes for the second image comprises employing at least one upscaling algorithm by the host device.

3. The method of claim 2, wherein the at least one upscaling algorithm comprises at least one of: an edge-aware upscaling algorithm, an interpolation-based upscaling algorithm, a machine learning-based upscaling algorithm, a bilateral filtering technique, a frequency-domain upscaling algorithm, a neural network-based upscaling algorithm.

4. The method of claim 1, wherein at the step of processing the at least one image to generate the first image of the first resolution with the first luminance plane and the first chrominance planes, the method further comprises determining an average of the pixel data of a given set of pixels from the at least one image sensor to create each pixel of the first image.

5. The method of claim 1, wherein the first resolution of the first image comprises a first sub-resolution and a second sub-resolution, wherein the first sub-resolution of the first chrominance planes corresponds to the second resolution of the second luminance plane of the second image in the given portion, and the second sub-resolution is down-sampled in a predefined range with respect to the first resolution.

6. The method of claim 1, wherein the first chrominance planes are downscaled to a resolution less than a resolution of the first luminance plane, and the second chrominance planes of the second image are downscaled to a resolution that is greater than the resolution of the first chrominance planes.

7. The method of claim 1, further comprising replacing the first chrominance planes of the first image with the second chrominance planes of the second image in the given portion of the second image, wherein the given portion overlaps with a corresponding portion of the first image that is in a field of view of the one or more cameras, and wherein the second chrominance planes are aligned with the first luminance plane of the first image in the given portion.

8. The method of claim 1, further comprising:
determining gaze directions of user's eyes;
determining a gaze area, based on the gaze directions of the user's eyes; and
determining the given portion of the first image, based on the gaze area.

9. The method of claim 1, wherein the first resolution lies in a range of 2 times the second resolution to a value proportional to a total number of pixels in the at least one image, times the second resolution.

10. The method of claim 1, further comprising employing a data transmission interface to transmit to the host device, the first image with the first luminance plane and the first chrominance planes, and the second image with the second luminance plane.

11. The method of claim 1, wherein the image processing system is a video-pass-through (VPT) system.

12. An image processing system comprising:
at least one image source configured to capture at least one image of an environment;
at least one imaging processor communicably coupled with the at least one image source, wherein the at least one imaging processor is configured to:
receive at least one image from the at least one image source, wherein the at least one image comprises pixel data from at least one image sensor of the at least one image source, wherein the at least one image source comprises one or more cameras with overlapping fields of view;
process the at least one image to generate:
a first image of a first resolution by downscaling the at least one image, wherein the first image comprises a first luminance plane and first chrominance planes; and
a second image of a second resolution by cropping a given portion of the at least one image corresponding to a region of interest, comprising a second luminance plane and second chrominance planes, wherein the second resolution is greater than the first resolution;
separate the second luminance plane from the second chrominance planes of the second image, wherein the second chrominance planes are omitted during transmission to a host device; and
transmit, to the host device:
the first image with the first luminance plane and the first chrominance planes, and
the second image with the second luminance plane; and
the host device comprising at least one first processor, wherein the at least one first processor is configured to:
receive, from the at least one imaging processor:
the first image with the first luminance plane and the first chrominance planes, and
the second image with the second luminance plane; and
reconstruct the second chrominance planes for the second image, by extracting the first chrominance planes from the first image and upscaling said first chrominance planes of the first image using the second luminance plane of the second image as a reference plane; and
reconstruct the second image of the second resolution, based on the reconstructed second chrominance planes and the second luminance plane.

13. The image processing system according to claim 12, wherein the at least one imaging processor is further configured to replace the first chrominance planes of the first image with the second chrominance planes of the second image in the given portion of the second image, wherein the given portion overlaps with a corresponding portion of the first image that is in a field of view of the one or more cameras, and wherein the second chrominance planes are aligned with the first luminance plane of the first image in the given portion.

14. The image processing system according to claim 12, further comprising a gaze-tracker, wherein the at least one imaging processor is further configured to:
determine gaze directions of user's eyes;
determine a gaze area, based on the gaze directions of the user's eyes; and
determine the given portion of the first image, based on the gaze area.

15. The image processing system according to claim 12, wherein the at least one imaging processor is further configured to transmit the first image with the first luminance plane and the first chrominance planes, and the second image with the second luminance plane to the host device via a data transmission interface.
